(19) United States
(12) Patent Application Publication
(10) Pub. No.: US 2019/0017757 A1
(43) Pub. Date: Jan. 17, 2019

(54) METHOD FOR CONNECTING TUBES OF A TUBE BUNDLE HEAT EXCHANGER TO A TUBESHEET OF THE TUBE BUNDLE HEAT EXCHANGER

(71) Applicant: Linde Aktiengesellschaft, Munchen (DE)

(72) Inventors: Christoph SEEHOLZER, Trostberg (DE); Georg WIMMER, Tussling (DE)

(73) Assignee: Linde Aktiengesellschaft, Munchen (DE)

(21) Appl. No.: 16/070,805

(22) PCT Filed: Jan. 18, 2017
(86) PCT No.: PCT/EP2017/025012

§ 371 Date: Jul. 18, 2018

(30) Foreign Application Priority Data
Jan. 19, 2016 (EP) 16000127.7

(51) Int. Cl. F28F 9/18; F28F 21/08; B23K 26/20; F28F 19/06; B23K 26/282

(52) U.S. Cl. CPC F28F 9/18; F28F 21/084; B23K 1/0012; F28F 19/06; B23K 26/282; B23K 26/206

(57) ABSTRACT

The present invention relates to a method for connecting tubes (125) of a tube bundle heat exchanger to a tube plate (130) of the tube bundle heat exchanger, wherein the tubes (125) are cohesively connected to the tube plate (130) by laser welding, during the course of which a laser beam (211) is generated and is focused on a location to be welded in a connecting region (250) between tube (125) and tube plate (130), wherein the laser beam (211) is moved so as to perform a first movement over the connecting region (250) and a second movement which is superposed on the first movement and which differs from the first movement, and wherein, by means of the second movement, melt bath dynamics are influenced in targeted fashion and/or a vapour capillary that forms is modified in targeted fashion.

The invention relates to a method for connecting tubes of a tube bundle heat exchanger to a tubesheet of the tube bundle heat exchanger and to a device for carrying it out.

### PRIOR ART

Tube bundle heat exchangers are designed to transfer heat from a first fluid to a second fluid. For this purpose, a tube bundle heat exchanger usually has a hollow cylinder, in the interior of which a multiplicity of tubes are arranged. One of the two fluids may be passed through the tubes, the other fluid through the hollow cylinder, in particular around the tubes. The tubes are fastened by their ends along the circumference thereof to tubesheets of the tube bundle heat exchanger

In the course of the production process of a tube bundle heat exchanger, the tubes are connected by their ends to the tubesheets, for example in a material-bonding manner. Depending on the number of tubes, up to several tens of thousands of tube-tubesheet connections are thereby produced.

DE 10 2006 031 606 A1 discloses a method for laser welding in which an oscillating movement is superposed on the advancing movement of the laser beam. This oscillating movement takes place substantially in a perpendicular direction in relation to the advancing direction. The oscillating movement is performed here for reasons of allowing better bridging of the gap.

It is desirable to provide a possible way of connecting tubes of a tube bundle heat exchanger to a tubesheet of the tube bundle heat exchanger to one another in a way that involves little effort and low costs and achieves high quality.

### DISCLOSURE OF THE INVENTION

According to the invention, a method for connecting tubes of a tube bundle heat exchanger to a tubesheet of the tube bundle heat exchanger and also a device for carrying it out with the features of the independent patent claims are proposed. Advantageous configurations are the subject of the dependent claims and of the description which follows. Embodiments and advantages of the method according to the invention and of the device according to the invention are evident in an analogous way from the following description.

The tubes are connected to the tubesheet in a material-bonding manner by means of laser welding. In the course of the laser welding, a laser beam is generated and focused on a location to be welded in a connecting region between the tube and the tubesheet. In this connecting region, the corresponding tube is intended to be connected to the tubesheet in a material-bonding manner. A corresponding weld seam between the tube and the tubesheet is created in this connecting region.

The focused laser beam is moved over the connecting region according to a first movement, or a main movement or advancing movement. This first movement takes place in particular along a first direction (direction of advancement) over the connecting region. This first direction corresponds in particular to a main direction of extent of the weld seam to be created. Superposed on this first movement of the laser beam is a second movement, in particular a so-called superposed movement, which is different from the first movement. This second movement takes place in particular along a second direction, which is in particular different from the first direction. In particular, an oscillation movement may be performed as this second movement. In order to connect the individual tubes to the tubesheet, according to the invention a laser welding in which two movements of the laser beam are superposed in the sense of vector geometry is consequently carried out. So-called laser welding with beam oscillation may be appropriately carried out. Moreover, according to the invention the melt bath and its properties are flexibly influenced by the second movement. In particular, melt bath dynamics can be flexibly influenced in a targeted manner and/or a vapor capillary that forms can be modified in a targeted manner, for example into an elongate or oval form. On the basis of such modified melt bath dynamics or such a modification of the vapor capillary, outgassing can be promoted in particular. Potential contaminants in a gap between the tube and the tubesheet may cause the risk of porosity occurring in the weld metal. This risk can be greatly reduced by influencing the melt bath dynamics and modifying the vapor capillary.

Suitable in particular as the second movement for the stated changing of the melt bath dynamics or the modification of the vapor capillary is a circular or elliptical movement, transversal deflections of 0.15-0.25 mm, in particular 0.23 mm, and longitudinal deflections of 0.15-0.25 mm, in particular 0.23 mm, being particularly advantageous here. The preferred frequency of the second movement is in this case 3000-4500 Hz, in particular 3500 Hz.

It should be emphasized at this point that the superposing of the two movements in the case of the present invention is used less for reasons of allowing better bridging of the gap than for purposes of reducing the pores.

Laser welding or laser beam welding should be understood in this context as meaning in particular a process such as that defined as process 52 according to DIN EN ISO 4063 (“Welding and allied processes—Nomenclature of processes and reference numbers”). In this case, energy is introduced by a laser beam into workpieces that are to be connected.

In the course of the laser welding, the laser beam is generated by an appropriate laser, for example by a CO₂ laser, CO laser, solid-state laser, in particular an Nd:YAG laser, Nd-glass laser, erbium-YAG laser, disk laser, fiber laser and/or diode laser. The laser beam generated is passed through optical elements such as lenses and/or mirrors, for example hollow mirrors, and focused on a location to be welded in the connecting region.

The device according to the invention for laser welding is accordingly designed for connecting tubes of a tube bundle heat exchanger to a tubesheet of the tube bundle heat exchanger and has a laser for generating a laser beam, a first control unit for activating a first traversing mechanism for producing a first movement of the laser beam and a second control unit for activating a second traversing mechanism for producing a second movement of the laser beam, the first and second control units being designed to carry out a method according to the invention. The first and second control units may be provided here combined in a common control unit. It may also be appropriate to combine the first and second traversing mechanisms in a common traversing mechanism. A separation into a first control unit and a second control unit and into a first traversing mechanism and a second traversing mechanism is advisable in particular whenever an existing device for laser welding is to be retrofitted to carry out a method according to the invention.

The device according to the invention for laser welding or a corresponding laser welding unit has in particular the laser and an appropriate housing, in which the optical elements are arranged. The laser may likewise be arranged in this housing or else outside the same, the laser beam in this case being coupled into the housing. For example, a number of the optical elements or all of the optical elements may be arranged in a laser head. The laser beam is coupled into this laser head.

The first and second movements of the laser beam, and consequently the production of the tube-tubesheet connection, may be carried out by an appropriate automated control. Consequently, the laser welding with beam oscillation can in particular be easily carried out in an automated manner. The automated control activates in particular appropriate elements of the device for laser welding in order to focus the laser beam and move it correspondingly.

The focused laser beam impinges on the location to be welded in the connecting region. The respective tube and/or the tubesheet are melted in a region around this location to be welded, whereby the melt bath is produced.

One specific embodiment of the laser welding is so-called deep welding. In this form of welding, the intensity of the laser beam generated lies above a predetermined limit value, for example above a limit value of 1 MW/cm², 2 MW/cm² or 4 MW/cm². This comparatively high intensity causes part of the material in the melt bath to evaporate, whereby a metal vapor is produced. Further absorption of the laser energy has the effect that this metal vapor is at least partially ionized, whereby a laser-induced plasma or metal vapor plasma is produced. The high intensity of the laser beam also has the effect that a welding capillary or vapor capillary also referred to as a “keyhole” forms in the melt. This vapor capillary is formed as a cavity, which is filled with the metal vapor plasma. Since the degree of absorption of the metal vapor plasma is in particular higher than the degree of absorption of the melt, the energy of the laser beam can be introduced almost completely into the respective tube or the tubesheet.

When the laser beam is moved over the connecting region, the molten material converges behind the laser beam and solidifies to form the weld seam. In the course of the main movement, the laser beam is moved along the first direction in order to connect the respective tube along the circumference thereof to the tubesheet, and in order consequently to create the corresponding weld seam around the tube. The main movement consequently represents in particular a circular movement around the tube or along the circumference thereof.

In particular at high power levels of the laser beam, it may prove to be difficult to guide the laser beam precisely along points in the connecting region at which the tube and the tubesheet touch, and to produce the melt bath precisely along these points. If no superposed movement were carried out and the melt bath were produced exclusively in the course of the main movement, it would therefore prove to be difficult to produce the melt bath precisely.

The additional second movement or superposed movement, which is superposed on the main movement, allows the melt bath to be produced with greater flexibility. This superposed second movement means that it is not just a matter of directing the laser beam as exactly as possible onto defined points in the connecting region in the course of the main movement and moving it as exactly as possible along the first direction. Instead, the laser beam can in particular be moved or oscillated around these corresponding points over an extended, wide range. The superposed movement allows a wider melt bath or a wider melting region than would be possible in the course of the main movement to be easily produced.

This consequently results in particular in additional degrees of freedom to direct the laser beam onto the connecting region and produce the melt bath. In particular, it does not have any adverse effect on the connection to be produced between the tube and the tubesheet if in the course of the main movement and/or superposed movement the laser beam cannot be guided absolutely exactly along a respective predetermined path, and consequently cannot be guided absolutely exactly along the respective direction. With just a main movement, this would be far more important, because then the melt bath would be produced exclusively by the main movement. If, on the other hand, a wide melt bath is produced by the combination of the main movement and the superposed movement, slight deviations of the individual movements from the respective predetermined path are not important, or not greatly, and do not adversely influence the melt bath and the connection to be produced.

Advantageously, the main direction of extent of the weld seam or the melt bath is predetermined by the first movement. The first movement consequently runs in particular along the locations at which the tube and the tubesheet touch, in particular along the connecting region or along a main direction of extent of the connecting region.

Preferably, a width of the weld seam or the melt bath is predetermined by the second movement, that is to say in particular an extent of the weld seam or the melt bath perpendicularly in relation to the first direction of movement or perpendicularly in relation to the main direction of extent of the weld seam. In particular, the width of the weld seam or the melt bath can be deliberately influenced by the second movement, and further in particular can be set to a predetermined value.

According to an advantageous embodiment, the first movement and/or the second movement are produced by movement of individual optical elements in a beam path of the laser beam. For this purpose, individual optical elements, in particular mirrors, may be displaced, pivoted, rotated and/or tilted. In particular, a first mirror, which can be rotated or tilted about a first axis, for example about a vertical axis, may be provided, and furthermore a second mirror, which is rotatable about a second axis, may be provided. This second axis may in particular extend perpendicularly in relation to the first axis and for example be a horizontal axis.

Alternatively or in addition, the first movement and/or the second movement may be advantageously produced by a device for laser welding or part of a device for laser welding being moved. This part or the overall laser welding device may for example be correspondingly moved, in particular displaced, pivoted, rotated and/or tilted, by means of a mechanical traversing mechanism. In the course of this, for example a system comprising a number of optical elements may be moved together. For example, a number of the optical elements or all of the optical elements may be arranged in the laser head and in particular this laser head may be moved. This allows in particular a multiplicity of optical elements to be moved together, in order to produce the main movement and/or superposed movement.

According to an advantageous embodiment, the first movement may be produced by part of the laser welding device being moved, preferably a part in which a multiplicity of optical elements are arranged, for example the laser head, and the second movement may be produced by individual optical elements in this part of the laser welding device being moved. Consequently, the main movement and the superposed movement are respectively produced in particular by means of different mechanisms. The corresponding part of the laser welding device and the corresponding individual optical elements may in this case be activated in particular independently of one another in order to superpose the two movements of the laser beam.

Preferably, the first movement is a circular movement, the radius of which corresponds substantially or completely to the radius of a tube. As already explained further above, the first movement consequently preferably runs circularly around the tube or along the circumference thereof. Consequently, the first direction is in particular tangential to the circumference of the tube.

Preferably, the second movement is a circular and/or elliptical movement (oscillation movement). The radius or the lateral extent of this oscillation movement should be less than the radius of the main movement, for example by a factor of 5, 10, 15 or more. Alternatively or in addition, the second movement may preferably be a translational movement perpendicular to the first movement, the direction of this second movement reversing alternately.

The tubes and/or the tubesheet are preferably respectively produced from steel or a nonferrous metal. In this context, steel should be understood in particular as meaning a material according to DIN EN 10020:2000-07, to be specific a “material of which the percentage by mass of iron is greater than that of every other element, the carbon content of which is generally less than 2% and which contains other elements. A limited number of chromium steels may contain more than 2% carbon, but 2% is the usual limit between steel and cast iron.” Nonferrous metal is generally understood as meaning a metal material that is not iron. In particular, in the case of tubes and/or tubesheets of steel or nonferrous metals, the risk of porosity occurring as a result of outgassing being promoted by changed melt bath dynamics and/or modification of the vapor bath capillary into an oval or elongate form when contaminants are present in a gap between the tube and the tubesheet is greatly reduced.

Advantageously, the tubes and/or the tubesheet are respectively produced from aluminum or an aluminum alloy. Such use of an aluminum material, that is to say of aluminum or an aluminum alloy, allows the tube bundle heat exchanger to be in particular of a much lighter construction than a tube bundle heat exchanger of other materials, for example of steel, high-grade steel or chromium-nickel steel. The tube bundle heat exchanger of an aluminum material has in particular an up to 50% lower mass than a corresponding tube bundle heat exchanger that is produced for example from chromium-nickel steel.

For working the tube or tubesheet of an aluminum material, it should be remembered that aluminum reacts quickly with oxygen, thereby forming aluminum oxide Al₂O₃ on the respective workpiece, that is to say on the tube and/or the tubesheet. On the workpieces to be welded there consequently forms an oxide layer, which should in particular be broken up or melted. Only when this oxide layer has been broken up can sufficient energy be introduced into the workpieces. This oxide layer usually has a very much higher melting point than the workpiece lying thereunder, that is to say than the part of the tube or the tubesheet lying under the oxide layer. For example, the oxide layer may have a melting point between 2000° C. and 2100° C., in particular substantially 2050° C. By contrast, depending on the exact composition, the workpiece lying thereunder may have a melting point between 500° C. and 700° C., in particular between 550° C. and 660° C.

Laser welding allows this oxide layer to be broken up, and in particular completely melted, since in laser welding it is possible in particular for a comparatively high concentration of energy to be achieved by the laser beam. Energy can be introduced particularly effectively into the workpiece lying thereunder. Tubes and tubesheets of an aluminum material can consequently be connected to one another by laser welding in a particularly effective way that involves little effort and low costs.

Conventional welding methods are only suitable to a certain extent for welding tubes and tubesheets of an aluminum material, since it is usually not possible to melt the complete oxide layer sufficiently. Unmelted oxides of the oxide layer in this case remain in the weld metal, which is referred to as oxide inclusions. Such oxide inclusions represent a clear separation or defect in the weld metal and in the weld seam. The creation of such oxide inclusions can be prevented by laser welding, and a neat, clean connection or weld seam without such defects can be produced.

Advantageously, a filler may be supplied in the course of the laser welding. Preferably, a shielding gas or process gas, preferably argon, helium, nitrogen, carbon dioxide, oxygen or a mixture of these gases mentioned, may also be supplied. The laser welding may however also be appropriately carried out without supplying shielding gas and/or filler.

The tube bundle heat exchanger to be produced has in its finished, ready-to-operate state in particular a multiplicity of tubes, which may for example be arranged in the interior of a hollow cylinder. The tube bundle heat exchanger may in this case have several hundreds, several thousands or even in particular several tens of thousands of tubes. Furthermore, in particular at least one tubesheet, which may for example be designed as a plate, is provided in the finished tube bundle heat exchanger. The tubes are securely connected at their ends along the circumference thereof to this tubesheet or to these tubesheets. The tubesheet has in particular bores or holes, which correspond in their diameter to the diameters of the tubes. In particular, each tube is fastened by one of its ends respectively to one of these bores.

In the course of the production of the tube bundle heat exchanger, the tubes are arranged within the tube bundle heat exchanger and aligned as desired. Then, the tubes are connected to the tubesheet or to the tubesheets in a material-bonding manner by laser welding with beam oscillation. In the course of production, in particular up to 25 000 tube-tubesheet connections are in this way produced by means of laser welding. When all of the tubes have been connected in a material-bonding manner to the tubesheet, a shell that forms the hollow cylinder can be arranged around the tubes.

Advantageously, tubes are connected to the tubesheet of a straight-tube heat exchanger to one another. The tubes of such a straight-tube heat exchanger run in particular in a straight line within the hollow cylinder. In this case, two tubesheets, which may be arranged at opposite ends of the straight-tube heat exchanger, are provided in particular. Each tube is connected here in a material-bonding manner by one of its ends respectively to one of these two tubesheets in each case.

Preferably, tubes may also be connected to the tubesheet of a U-tube heat exchanger to one another. The tubes of such a U-tube heat exchanger run in particular in a U-shaped manner within the hollow cylinder. Such a heat exchanger may in particular have only one tubesheet. Since the tubes are in this case bent in a U-shaped manner, they may be respectively fastened by both their ends to the same tubesheet. It is also conceivable to use two tubesheets arranged next to one another.

Preferably, tubes and tubesheets of a helically coiled tube bundle heat exchanger may also be connected to one another. In the case of such a helically coiled tube bundle heat exchanger, the tubes are in particular coiled within the hollow cylinder, i.e. the tubes run in particular in a circular or helical manner around an axis, in particular around a longitudinal axis or main axis of extent of the tube bundle heat exchanger. In particular, a core tube, around which the tubes are arranged in a circular or helical manner, may be provided in the interior of the hollow cylinder. Such a helically coiled tube bundle heat exchanger has in particular two tubesheets arranged at opposite ends.

In addition, still further advantages can be achieved by laser welding the tube-tubesheet connections. In the case of laser welding, a welding rate that is comparatively very high can be achieved, whereby the tube-tubesheet connections can be produced particularly quickly and efficiently. Furthermore, reproducible tube-tubesheet connections can be produced with consistent quality by means of laser welding. In particular, with laser welding comparatively narrow weld seams can be created, whereby it is possible to avoid weld seams of neighboring tubes influencing one another.

The comparatively thick tubesheet (in particular in comparison with the wall thicknesses of the tubes) has in particular a comparatively high thermal conductivity, so that heat introduced is dissipated very quickly. On the other hand, the comparatively thin or thin-walled tubes appropriately have a comparatively low thermal conductivity, so that heat introduced cannot be dissipated quickly. Laser welding allows sufficient energy to be introduced into the tubesheet to melt it in spite of its comparatively high thermal conductivity. It can nevertheless be ensured that the tubes are not melted back prematurely.

Further advantages and configurations of the invention are evident from the description and the accompanying drawing.

It goes without saying that the features mentioned above and still to be explained below can be used not only in the respectively specified combination but also in other combinations or on their own without departing from the scope of the present invention.

The invention is schematically represented in the drawing on the basis of an exemplary embodiment and is described in detail below with reference to the drawing.

### BRIEF DESCRIPTION OF THE DRAWINGS

FIG. 1 schematically shows a preferred configuration of a tube bundle heat exchanger which has been produced by means of a preferred embodiment of a method according to the invention.

FIG. 2 schematically shows a preferred configuration of a device according to invention which is designed to carry out a preferred embodiment of a method according to the invention.

FIG. 3 schematically shows part of a preferred configuration of a device according to the invention which is designed to carry out a preferred embodiment of a method according to the invention.

FIG. 4 schematically shows part of a tube bundle heat exchanger which is worked in the course of a preferred embodiment of a method according to the invention.

### EMBODIMENT(S) OF THE INVENTION

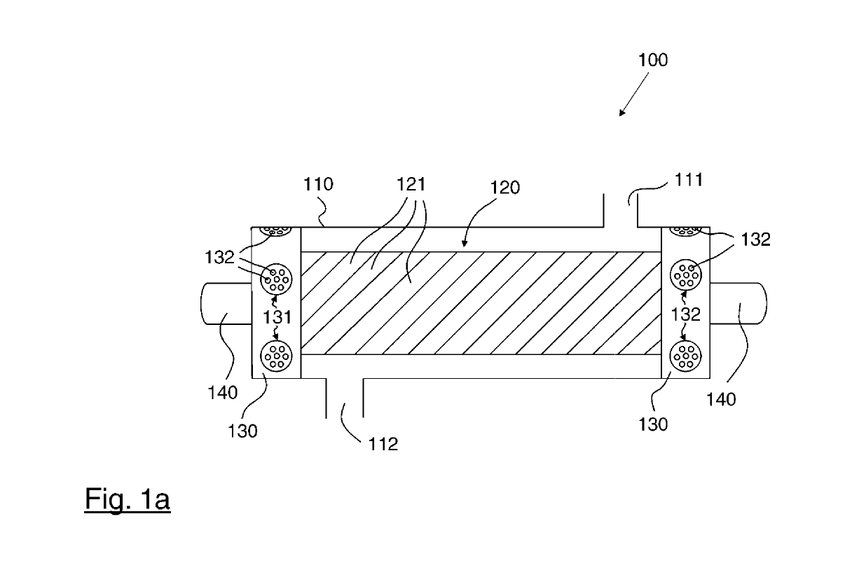

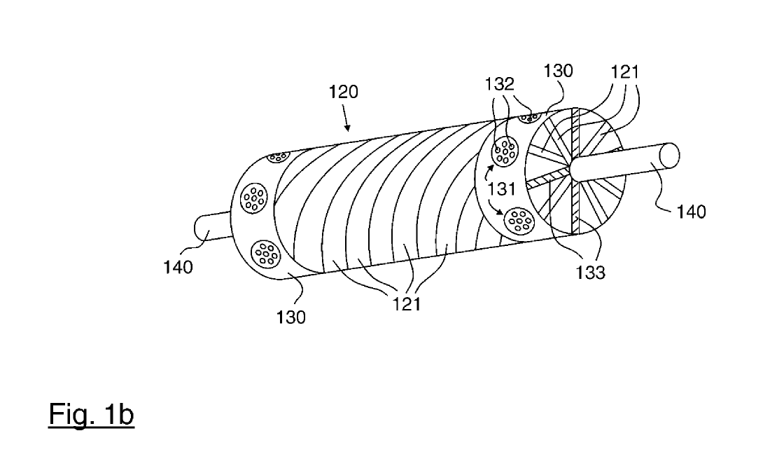

In FIG. 1, a preferred configuration of a tube bundle heat exchanger 100 is schematically shown in the form of a helically coiled tube bundle heat exchanger which has been produced by means of a preferred embodiment of a method according to the invention.

In FIG. 1a, the tube bundle heat exchanger 100 is shown in a sectional view. The tube bundle heat exchanger 100 has a shell 110, which has a fluid inlet 111 and a fluid outlet 112 in order to pass a first fluid through the shell 110.

Arranged within the shell 110 is a bundle of tubes 120 comprising a multiplicity of tubes 121. A second fluid may be passed through the tubes 121. The tubes 121 are coiled helically around a core tube 140. The individual tubes 121 are connected in a material-bonding manner to tubesheets 130 of the heat exchanger 100.

The tubesheets 130 have along their circumference bore regions 131 with bores 132, each of the tubes 121 of the bundle of tubes 120 being connected in a material-bonding manner to the respective tubesheet 130 at one of these bores 132.

The heat exchanger 100, the tubes 121 and the tubesheets 130 are for example produced from an aluminum alloy, e.g. from an aluminum-magnesium-manganese alloy.

In FIG. 1b, part of the helically coiled tube bundle heat exchanger 100 (the bundle of tubes 120, the tubesheets 130 and the core tube 140) from FIG. 1a is shown in a perspective view. As can be seen in FIG. 1b, the tubesheets 130 are fastened to the core tube 140 for example by way of supporting arms 133.

In order to connect each of the tubes 121 in a material-bonding manner to the respective tubesheet 130 at one of the bores 132, these material-bonding tube-tubesheet connections are produced in the course of a preferred embodiment of the method according to the invention by laser welding with beam oscillation.

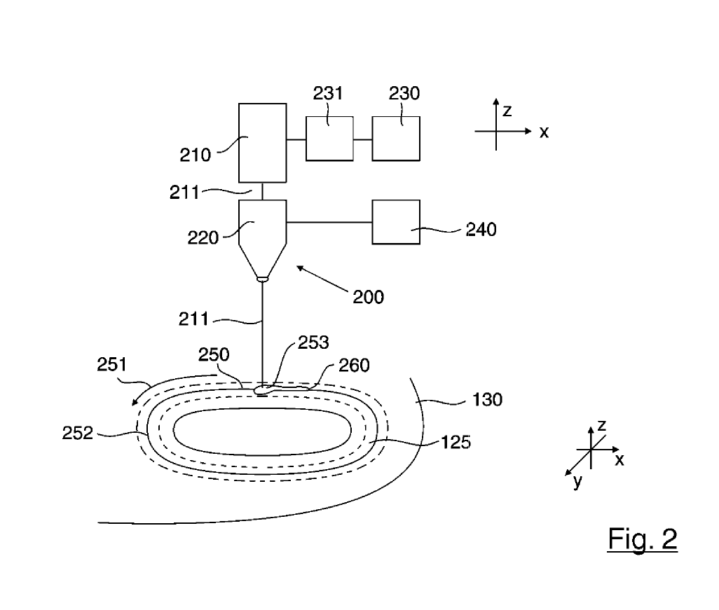

In FIG. 2, a preferred configuration of a device 200 according to the invention for laser welding which is designed to carry out such a preferred embodiment of the method according to the invention is schematically shown. In FIG. 2, it is shown by way of example how with this laser welding unit 200 one of the tubes, denoted in FIG. 2 by 125, can be connected in a material-bonding manner to one of the tubesheets 130 of the helically coiled tube bundle heat exchanger 100 according to FIG. 1 in the course of its production process.

The laser welding unit 200 has a laser 210, for example an Nd:YAG laser, and a laser head 220. The laser 210 generates a laser beam 211, which is coupled into the laser head 220. Appropriate optical elements are arranged in the laser head 220 in order to focus the laser beam 211 on a location to be welded in a connecting region 250 between the tube 125 and the tubesheet 130.

The focused laser beam 211 impinges on the location to be welded in the connecting region 250, whereby the tube 125 and the tubesheet 130 are at least partially melted, so that a melt bath 253 is created. When the laser beam is moved over the connecting region, the melted material converges behind the laser beam and solidifies to form the weld seam 260.

The laser welding unit 200 also comprises a first control unit 230 and a first traversing mechanism 231 in order to produce a first movement of the laser beam 211. For this purpose, the traversing mechanism 231 is appropriately activated by the first control unit 230.

By means of the traversing mechanism 231, in particular the entire laser welding unit 200 can be moved, in particular both the laser 210 and the laser head 220 together. In the course of this, the laser welding unit 200 may for example be rotated both about a z axis and about an x axis.

The tubesheet 130 in this case extends for example in a plane defined by the x axis and a y axis, the z axis being oriented perpendicularly in relation to this plane.

According to this first movement or main movement, the laser beam 211 is moved over the connecting region along a first direction 251. This first direction 251 corresponds in particular to a main direction of extent of the connecting region or a main direction of extent of the weld seam 260 produced. This first direction 251 also extends in particular parallel to a circumference 252 of the tube 125.

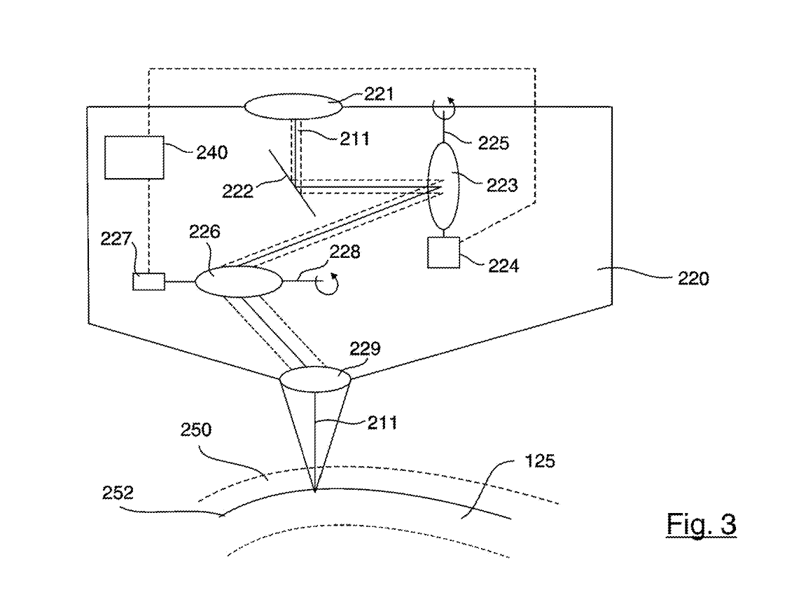

A second control unit 240 and a second traversing mechanism are also provided, in order to produce a second movement of the laser beam 211. The second traversing mechanism is explained in detail further below with reference to FIG. 3. It should be pointed out that the first control unit 230 and the second control unit 240 may be provided combined in a common control unit. The same applies to the two traversing mechanisms.

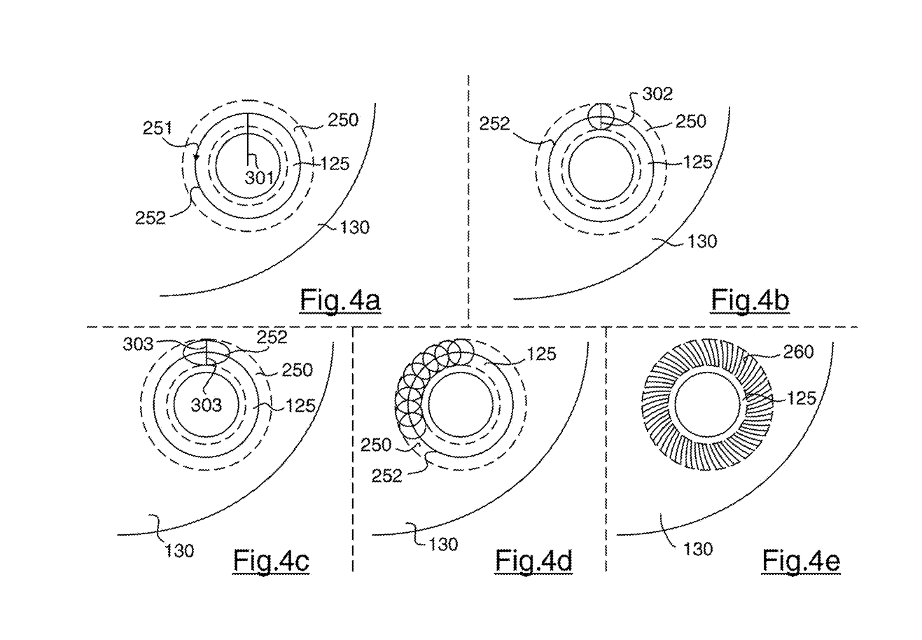

Individual optical elements in the laser head 220 can be moved by means of the second traversing mechanism, whereby a second movement is superposed on the first movement of the laser beam 211. This second movement is explained in detail further below with reference to FIG. 4.

In FIG. 3, the laser head 220 from FIG. 2 is shown schematically in a sectional view. The laser beam 211 generated by the laser 210 is coupled into the laser head by a lens 221 and in this example first impinges therein on a deflecting mirror 222. The laser beam 211 then impinges on a first rotatable mirror 223 and after that on a second rotatable mirror 226. Subsequently, the laser beam 211 impinges on a focusing lens 229, after which it leaves the laser head.

The rotatable mirrors 223 and 226 may be formed in each case for example as hollow mirrors. The first mirror 223 may be rotated about a first axis 225 by a first adjusting mechanism 224. The second mirror 226 may be rotated about a second axis 228 by a second adjusting mechanism 227. The axes 225 and 228 are in particular perpendicular to one another. The adjusting mechanisms 224 and 227 together form the aforementioned second traversing mechanism for producing the second movement of the laser beam 211.

For this purpose, the second control unit 240 activates the adjusting mechanisms 224 and 227 in order to rotate the rotatable mirrors 223 and 226 correspondingly to superpose the second movement of the laser beam 211 on the first movement.

In FIG. 4, examples of the first movement and the second movement of the laser beam, which can carried out in the course of a preferred embodiment of a method according to the invention, are schematically shown. In FIGS. 4a to 4e, the tube 125 and part of the tubesheet 130 are respectively shown schematically in a plan view.

In FIG. 4a, an example of the first movement of the laser beam 211 is schematically shown. The first movement in this case runs along the circumference 252 of the tube 125 in the connecting region 250. The first movement is consequently a circular movement around the center point of the tube 125; the first direction of movement 251 runs parallel to the circumference 252 of the tube 125. A radius 301 of this circular movement corresponds in this case for example to the outer radius of the tube 125.

In FIG. 4b, an example of the second movement of the laser beam 211 is schematically shown. The second movement is in this example likewise a circular movement. The diameter 302 of this circular movement corresponds in this example to a width of the connecting region 250. In particular, the diameter 301 of this circular movement likewise corresponds to the width of the weld seam 260.

The second movement may for example also be elliptical, as shown in FIG. 4c. In this example, for example twice the length of the semi-minor axis 303 of the corresponding ellipse corresponds to the width of the connecting region 250 and further in particular to the width of the weld seam 260.

In FIG. 4d, an example of the movement of the laser beam 211 as a superposition of the first movement according to FIG. 4a and the second movement according to FIG. 4b is schematically shown. The laser beam 211 is consequently moved over the connecting region 250 as a superposition of a circular movement with a radius 301 and a circular movement with a diameter 302. The center point of the second movement in the form of the circular movement according to FIG. 4b lies in this case for example on the circumference 252 of the tube 125.

For positive influencing of the melt bath dynamics and targeted modification of the vapor capillary that is formed during the laser welding, in particular in the case of deep welding with comparatively high laser beam intensities (cf. the relevant statements further above in the description), the second movement is performed with a transversal deflection of between 0.15 and 0.25 mm and a longitudinal deflection of 0.15 to 0.25 mm. If the longitudinal deflection and the transversal deflection are the same, there is a circular second movement, otherwise an elliptical second movement is obtained. A circular second movement with a transversal deflection and a longitudinal deflection of 0.23 mm has proven to be particularly advantageous. The frequency of this second movement lies here in the range of 3000-4500 Hz; in particular, a frequency of 3500 Hz is particularly advantageous. In this way, the risk of porosity in the welded connection can be greatly reduced by the second movement.

In FIG. 4e, an example of a produced tube-tubesheet connection is shown. The movement of the laser beam 211 according to FIG. 4d has the effect that the tube 125 and the tubesheet 130 are melted in particular over the entire width of the connecting region. Once the melt has solidified, the weld seam 260 has consequently been produced, the width of the weld seam 260 corresponding to the width of the connecting region 250.

### LIST OF REFERENCE NUMERALS

100 Tube bundle heat exchanger, helically coiled tube bundle heat exchanger

110 Shell

111 Fluid inlet

112 Fluid outlet

120 Bundle of tubes

121 Tubes

125 Tube

130 Tubesheets

131 Bore region

132 Bores

133 Supporting arms

140 Core tube

200 Laser welding unit, device for laser welding

210 Laser, Nd:YAG laser

211 Laser beam

220 Laser head

221 Lens

222 Deflecting mirror

223 First rotatable mirror, hollow mirror

224 First adjusting mechanism

225 First axis

226 Second rotatable mirror, hollow mirror

227 Second adjusting mechanism

228 Second axis

229 Focusing lens

230 First control unit

231 First traversing mechanism

240 Second control unit

250 Connecting region

251 First direction; main direction of extent of the weld seam

252 Circumference of the tube 125

253 Melt bath

260 Weld seam

301 Radius of the circular first movement

302 Diameter of the circular second movement

303 Semi-minor axis of the elliptical second movement

1. A method for connecting tubes (121, 125) of a tube bundle heat exchanger (100) to a tubesheet (130) of the tube bundle heat exchanger (100),
wherein the tubes (121, 125) are connected to the tubesheet (130) in a material-bonding manner by means of laser welding, in the course of which a laser beam (211) is generated and focused on a location to be welded in a connecting region (250) between the tube (125) and the tubesheet (130),
wherein the laser beam (211) is moved in such a way that it produces a first movement over the connecting region (250) and a second movement superposed on the first movement, which is different from the first movement, and
wherein melt bath dynamics are influenced by the second movement in a targeted manner and/or a vapor capillary that forms is modified in a targeted manner.

2. The method as claimed in claim 1, wherein the vapor capillary that is formed is modified into an elongate or oval form.

3. The method as claimed in claim 1, wherein a main direction of extent (251) of a weld seam (260) is predetermined by the first movement and/or wherein a width (302) of the weld seam (260) is predetermined by the second movement.

4. The method as claimed in claim 1, wherein the first movement and/or the second movement are produced by movement of individual optical elements (223, 226) in a beam path of the laser beam (211).

5. The method as claimed in claim 4, wherein at least one mirror (223, 226) in the beam path of the laser beam (211) is rotated.

6. The method as claimed in claim 1, wherein the first movement and/or the second movement are produced by a device for laser welding (200) or part of a device for laser welding (200) being moved.

7. The method as claimed in claim 6, wherein a laser head (220) of the device for laser welding (200) is moved.

8. The method as claimed in claim 1, wherein the first movement is a circular movement, the radius (301) of which corresponds substantially or completely to the radius of a tube (125).

9. The method as claimed in claim 1, wherein the second movement is a circular and/or elliptical and/or translational movement alternating in its direction.

10. The method as claimed in claim 9, wherein the second movement is performed with a transversal deflection of 0.15-0.25 mm, in particular 0.23 mm, and/or with a longitudinal deflection of 0.15-0.25 mm, in particular 0.23 mm.

11. The method as claimed in claim 9, wherein the second movement is performed with a frequency of 3000-4500 Hz, in particular 3500 Hz.

12. The method as claimed in claim 1, wherein the tubes (121) and/or the tubesheet (130) are respectively produced from steel or a nonferrous metal and/or are respectively produced from aluminum or an aluminum alloy.

13. The method as claimed in claim 1, wherein the tubes (121) and the tubesheet (130) of a straight-tube heat exchanger, of a U-tube heat exchanger or of a helically coiled tube bundle heat exchanger (100) are connected to one another.

14. The method as claimed in claim 1,
wherein the laser beam (211) is generated by a CO₂ laser, CO laser, solid-state laser, Nd:YAG laser (210), Nd-glass laser, erbium-YAG laser, disk laser, fiber laser and/or diode laser.

15. A device (200) for laser welding, which is designed for connecting tubes (121, 125) of a tube bundle heat exchanger (100) to a tubesheet (130) of the tube bundle heat exchanger (100), wherein the device (200) has a laser (210) for generating a laser beam (211), a first control unit (230) for activating a first traversing mechanism (231) for producing a first movement of the laser beam (211) and a second control unit (240) for activating a second traversing mechanism for producing a second movement of the laser beam (211), the first and second control units (230, 240) being designed to carry out a method as claimed in claim 1.
